(19) United States
(12) Patent Application Publication
(10) Pub. No.: US 2024/0391245 A1
(43) Pub. Date: Nov. 28, 2024

(54) LIQUID EJECTION APPARATUS AND LIQUID EJECTION HEAD

(71) Applicant: CANON KABUSHIKI KAISHA, Tokyo (JP)

(72) Inventor: KYOSUKE TODA, Kanagawa (JP)

(21) Appl. No.: 18/653,032

(22) Filed: May 2, 2024

(30) Foreign Application Priority Data
May 23, 2023 (JP) 2023-084328

(51) Int. Cl. B41J 2/18; B41J 2/175

(52) U.S. Cl. CPC B41J 2/18; B41J 2/17596

(57) ABSTRACT

There is provided a technique capable of eliminating sedimentation of contained material created in a circulation path while realizing stable liquid circulation. A circulation control unit can execute: first circulation in which liquid flows from a first pressure control chamber, passes through an ejection unit which ejects liquid and a second pressure control chamber, and then returns to the first pressure control chamber by using a pressure difference between the first pressure control chamber and the second pressure control chamber; and second circulation in which liquid is collected from the first pressure control chamber, the second pressure control chamber, and the ejection unit to a supply unit which can supply liquid to the first pressure control chamber without being controlled by negative pressures corresponding to the first pressure control chamber and the second pressure control chamber, respectively, while liquid is supplied to the first pressure control chamber.

### BACKGROUND OF THE INVENTION

### Field of the Invention

The present invention relates to a liquid ejection apparatus and a liquid ejection head.

### Description of the Related Art

In recent years, a liquid ejection apparatus which ejects liquid has been used for various purposes such as a printing apparatus which ejects ink and performs printing and a modeling apparatus for electrode formation or biochip production. Accordingly, the liquid ejection apparatus is required to stably eject various kinds of liquids such as a liquid containing material in high concentration and a liquid containing material of high specific gravity.

Japanese Patent Laid-Open No. 2020-121416 discloses a technique to discharge bubbles in ink and eliminate sedimentation of a pigment dispersed in ink. In the technique disclosed in Japanese Patent Laid-Open No. 2020-121416, there are formed a main circulation path which can supply ink from a common liquid chamber to a pressure chamber communicating with an ejection opening and a sub circulation path which feeds ink from one side to the other side in the extending direction of the common liquid chamber so as to sandwich a position in the main circulation path from which ink flows into the common liquid chamber. Bubble discharge and sedimentation elimination are realized by switching between the two types of circulation paths.

In the technique disclosed in Japanese Patent Laid-Open No. 2020-121416, however, if a pressure regulator or the like having a pressure regulating function is used to execute stable ink circulation at constant pressure in the main circulation path, it is difficult to perform control such that the flow rate of ink is temporarily increased. Thus, it is considered that the sub circulation path is used. In this case, however, sedimentation cannot be eliminated in a portion of the main circulation path other than the common liquid chamber shared with the sub circulation path.

### SUMMARY OF THE INVENTION

The present invention has been accomplished in view of the above problem and provides a technique capable of eliminating sedimentation of contained material in a circulation path while realizing stable liquid circulation.

A liquid ejection apparatus is equipped with:
a first pressure control chamber controlled to have a first negative pressure;
a second pressure control chamber connected to the first pressure control chamber through a flow path and controlled to have a second negative pressure less than the first negative pressure;
an ejection unit configured to eject, from an ejection opening, liquid supplied from the first pressure control chamber and collect, to the second pressure control chamber, liquid not ejected from the ejection opening;
a supply unit configured to supply stored liquid to the first pressure control chamber and collect liquid from the first pressure control chamber, the second pressure control chamber, and the ejection unit; and
a circulation control unit configured to control circulation of liquid among the first pressure control chamber, the second pressure control chamber, the ejection unit, and the supply unit,
wherein the circulation control unit is configured to execute:
first circulation in which liquid flows from the first pressure control chamber, passes through the ejection unit and the second pressure control chamber, and then returns to the first pressure control chamber by using a pressure difference between the first pressure control chamber and the second pressure control chamber; and
second circulation in which liquid is collected from the first pressure control chamber, the second pressure control chamber, and the ejection unit to the supply unit without being controlled by negative pressures corresponding to the first pressure control chamber and the second pressure control chamber, respectively, while liquid is supplied to the first pressure control chamber.

According to the present invention, sedimentation of contained material can be eliminated in a circulation path while realizing stable liquid circulation.

Further features of the present invention will become apparent from the following description of exemplary embodiments with reference to the attached drawings.

### BRIEF DESCRIPTION OF THE DRAWINGS

FIG. 1 is a schematic configuration diagram of a printing apparatus;

FIG. 2 is an external view of a print head;

FIG. 3 is an exploded configuration diagram of the print head;

FIG. 4 is a cross section configuration diagram of a printing element substrate;

FIG. 5 is a schematic configuration diagram of a circulation unit;

FIG. 6 is an exploded configuration diagram of the circulation unit;

FIG. 7 is a perspective view of the circulation unit;

FIGS. 8A and 8B are diagrams showing ink flow in the circulation unit;

FIG. 9 is a diagram showing an ink circulation path in the printing apparatus;

FIG. 10 is a block diagram showing a configuration of a control system of the printing apparatus;

FIG. 11 is a diagram illustrating second circulation;

FIG. 12 is a diagram showing an ink circulation path in a printing apparatus according to another embodiment;

FIG. 13 is a diagram illustrating second circulation according to another embodiment; and

FIGS. 14A and 14B are diagrams showing ink flow in the vicinity of each pressure control chamber and each pressure control mechanism.

### DESCRIPTION OF THE EMBODIMENTS

An example of embodiments of a liquid ejection apparatus and a liquid ejection head will be described below with reference to the accompanying drawings. It should be noted that the following embodiments do not limit the present invention and not all of the combinations of features explained in the embodiments are necessarily essential for solving the problem of the present invention. The positions, shapes, and the like of constituent elements described in the embodiments are merely shown as examples and the invention is not limited to these examples.

### First Embodiment

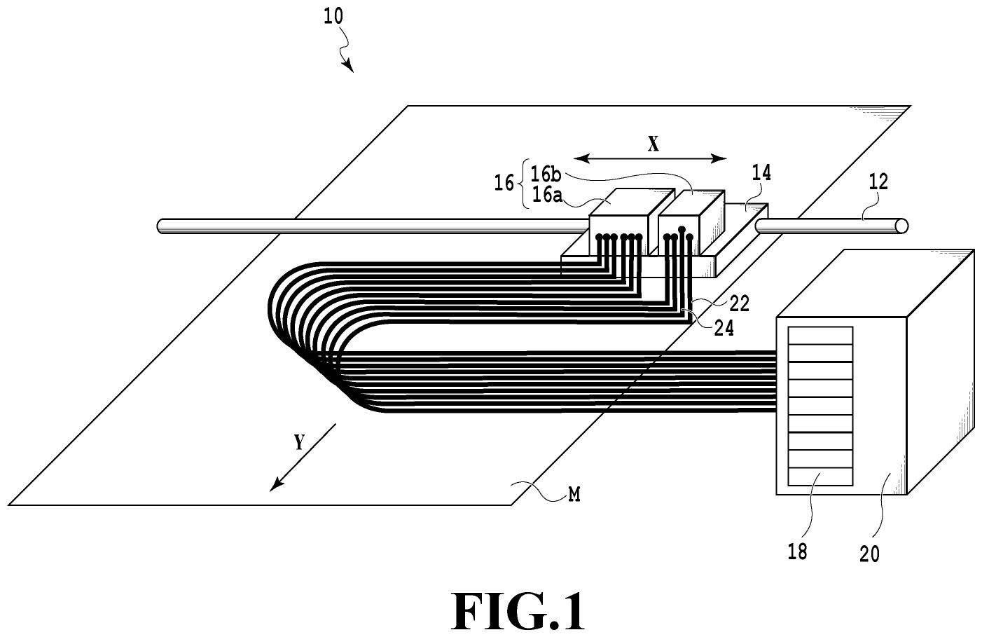

First, a liquid ejection apparatus according to a first embodiment will be described with reference to FIGS. 1 to 11. In the present embodiment, a printing apparatus which ejects ink to a print medium under an inkjet system and performs printing is explained as an example of the liquid ejection apparatus. Accordingly, in the present embodiment, a liquid ejection head is described as a print head. Examples of the printing apparatus include apparatuses such as a copier, a facsimile having a communication system, and a word processor having a printing function, and an industrial printing apparatus compositely combined with various processing apparatuses. Further, the liquid ejection apparatus according to the present invention is also applicable to, for example, production of biochips, printing of electronic circuits, and printing on nonabsorbent media.

### Configuration of Printing Apparatus

FIG. 1 is a schematic configuration diagram of the printing apparatus. A printing apparatus 10 of FIG. 1 comprises a carriage 14 movably provided on a guide shaft 12 extending in an X direction (predetermined direction) and a print head (liquid ejection head) 16 mounted on the carriage 14 and capable of ejecting ink as liquid under an inkjet system. Thus, in the printing apparatus 10, the print head 16 is movable in the X direction via the carriage 14. In the printing apparatus 10, in a case where a print medium M is conveyed by a conveying section (not shown) in a Y direction intersecting with (in the present embodiment, orthogonal to) the X direction and reaches a printing start position, a printing operation of ejecting ink from the print head 16 moving in the X direction to the print medium M is executed. After that, a conveyance operation of conveying the print medium M a predetermined amount by the conveying section is executed and the printing operation is then executed again. In this manner, the printing apparatus 10 alternately executes the printing operation and the conveying operation and thereby executes printing.

The print head 16 comprises two types of print heads: a print head 16a capable of ejecting six types of inks and a print head 16b capable of ejecting three types of inks. That is, in the present embodiment, nine types of inks can be ejected from the print head 16. However, the print head 16 may comprise a single type of print head or three or more types of print heads. Further, the number of types of inks ejectable from the print heads 16a and 16b is not limited to the above number. Further, what is ejected from the print head 16 is not limited to ink and the print head 16 may be configured to eject liquid such as a processing liquid for applying predetermined processing to ejected ink.

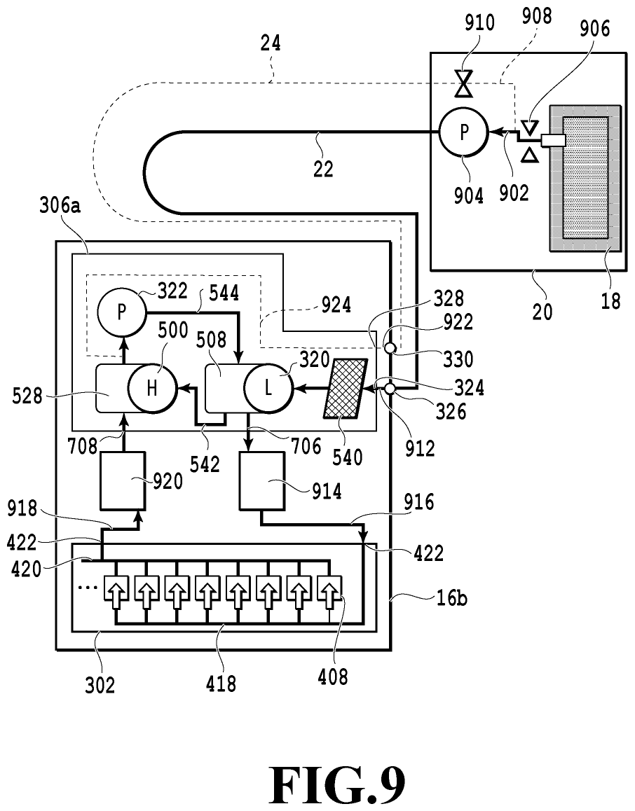

The printing apparatus 10 comprises an ink supply unit 20 capable of supplying ink stored in an ink tank 18 to the print head 16. The ink tank 18 separately stores different types of inks ejected from the print head 16. In the present embodiment, nine types of inks are stored in the ink tank 18. The ink tank 18 provided in the ink supply unit 20 is connected to the print heads 16a and 16b via supply tubes 22. The ink supply unit 20 is provided with a pump 904 (see FIG. 9) which pressurizes and supplies ink from the ink tank 18 to the print head 16 through the supply tubes 22.

As will be described later in detail, in the present embodiment, the print head 16b is configured to eject a white ink containing material of high specific gravity (pigment). A collection tube 24 is connected to the print head 16b to collect the white ink from the print head 16b. The collection tube 24 has one end connected to the print head 16b and the other end connected to a tank storing the white ink in the ink tank 18. In the present embodiment, a single collection tube 24 is provided in only the print head 16b, but the number of collection tubes 24 is not limited to this. That is, in a case where the print heads 16a and 16b eject a plurality of inks containing material of high specific gravity, namely inks prone to cause sedimentation of contained material, the collection tubes 24 corresponding to the number of inks are provided.

### Configuration of Print Head

Next, the configuration of the print head 16 will be described. In the present embodiment, an ink prone to cause sedimentation of contained material is ejected from the print head 16b. An “ink prone to cause sedimentation of contained material” is herein simply referred to as an “ink prone to cause sedimentation” as appropriate. Since a publicly-known technique can be used for the print head 16a not configured to eject an ink prone to cause sedimentation, the detailed description of the configuration of the print head 16a will be omitted. That is, the following description will describe in detail the configuration of the print head 16b connected to the collection tube 24.

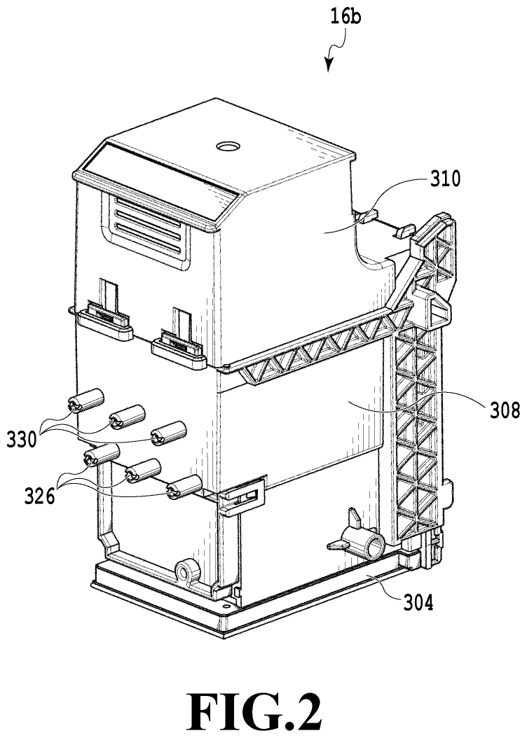

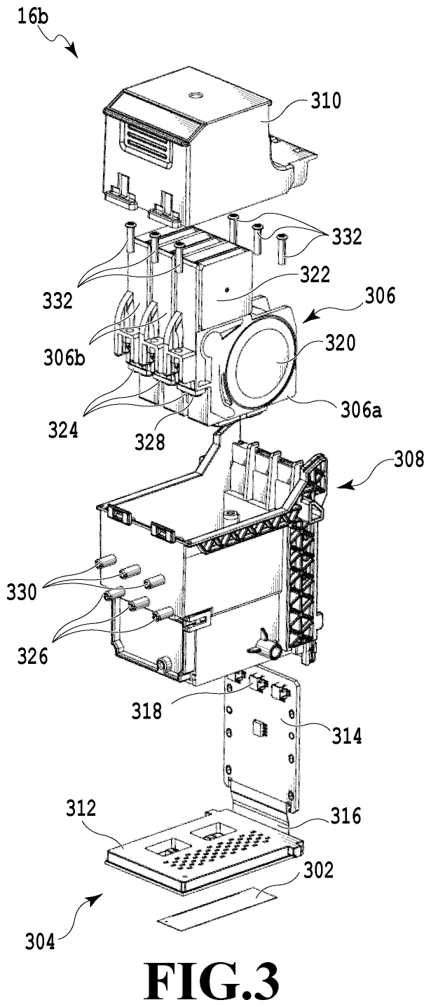

FIG. 2 is an external view of the print head 16b. FIG. 3 is an exploded view of the print head 16b. The print head 16b comprises a printing element unit 304 comprising a printing element substrate 302, a circulation unit 306 which circulates ink supplied to the printing element substrate 302, and a housing unit 308 and a cover 310 which cover the circulation unit 306 (see FIG. 3). The print head 16b is fixedly supported on the carriage 14 by a positioning section (not shown) and an electrical contact provided in the carriage 14.

### Printing Element Unit 304

The printing element unit 304 comprises the printing element substrate 302 capable of ejecting supplied ink and a supporting member 312 having connection flow paths 916 and 918 (see FIG. 9) which connect flow paths formed in the circulation unit 306 and printing element substrate 302 (see FIG. 3). The printing element unit 304 also comprises an electrical contact substrate 314 connected to the electrical contact provided in the carriage 14 and an electrical wiring tape 316 which connects the electrical contact substrate 314 to the printing element substrate 302.

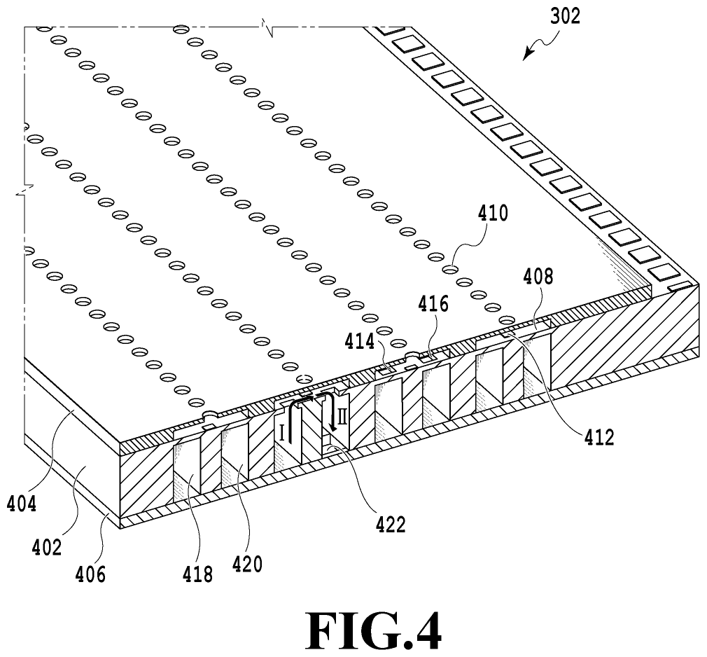

The electrical contact substrate 314 is configured to electrically connect with the electrical contact of the carriage 14 and supplies a drive signal and drive energy to a circulation pump 322 mounted on the circulation unit 306 via a circulation unit connector 318 and pump wiring (not shown). The electrical contact substrate 314 also supplies a drive signal and drive energy to the printing element substrate 302 via the electrical wiring tape 316 to drive ejection energy generating elements 412 (see FIG. 4) which are printing elements. The printing element substrate 302 and the electrical wiring tape 316 may be electrically connected by an anisotropy conductive film, wire bonding, soldering or the like, but the method of electrically connecting the printing element substrate 302 and the electrical wiring tape 316 is not limited to this. In the present embodiment, the printing element substrate 302 and the electrical wiring tape 316 are connected by wire bonding and the portion electrically connected by wire bonding is sealed with a sealing material.

The printing element unit 304 is bonded and fixed to the housing unit 308, whereby the flow paths in the circulation unit 306 fixed to the housing unit 308 communicate with the flow paths in the printing element substrate 302 through the connection flow paths 916 and 918 formed in the supporting member 312. Alternatively, the printing element unit 304 and the housing unit 308 may be connected via an elastic member such as a rubber or elastomer as a sealing member. Incidentally, the housing unit 308 is formed by combining parts injection-molded from a filler-containing resin in order to form an engaging section (not shown) with the positioning section of the carriage 14 and ink flow paths.

### Circulation Unit 306

The print head 16b is configured to eject three types of inks including an ink prone to cause sedimentation. In the present embodiment, the print head 16b is configured to eject a white ink prone to cause sedimentation and a light magenta ink and a light cyan ink which are inks less prone to cause sedimentation, that is, inks having a relatively low probability of sedimentation. A circulation unit 306a corresponds to the white ink and circulation units 306b correspond to the light magenta and light cyan inks. That is, the white ink supplied from the supply tube 22 is fed to the printing element unit 304 through the circulation unit 306a. The light magenta and light cyan inks supplied from the supply tubes 22 are fed to the printing element unit 304 through the circulation units 306b.

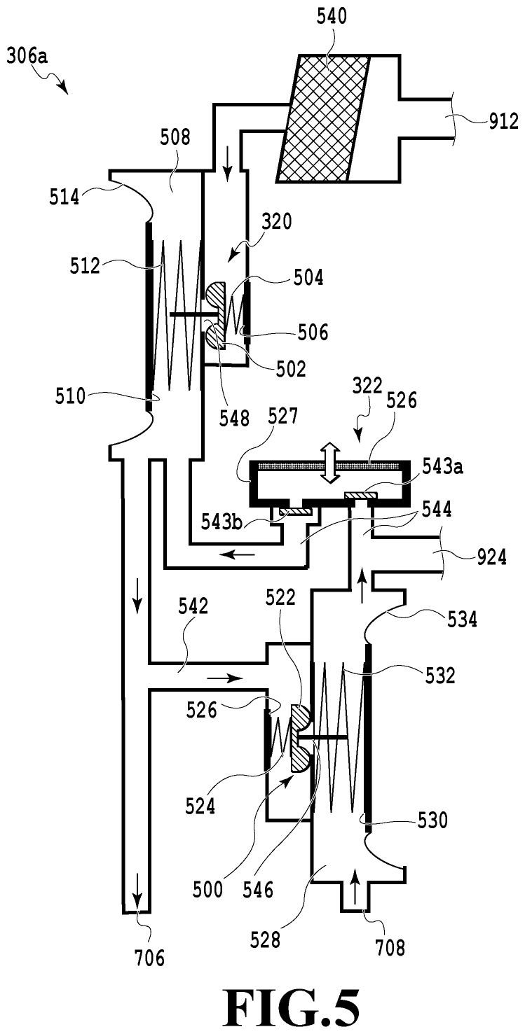

The circulation units 306a and 306b each comprise a first pressure control mechanism 320, a second pressure control mechanism 500 (see FIG. 5), and the circulation pump 322. The configuration of the first pressure control mechanism 320, second pressure control mechanism 500, and circulation pump 322 will be described later. The circulation units 306a and 306b each comprise a supply port 324 to cause ink to flow therein. Here, the housing unit 308 to which the supply tubes 22 are connected via connecting portions 326 comprises flow paths 912 (see FIG. 9) connected to the supply ports 324 of the fixed circulation units 306a and 306b. Accordingly, ink supplied from the supply tubes 22 flows into the supply ports 324 through the flow paths 912.

The circulation units 306a and 306b each comprise a collection port 328 to cause ink to flow out thereof. Here, the housing unit 308 to which the collection tube 24 is connected via a connecting portion 330 comprises flow paths 922 (see FIG. 9) connected to the collection ports 328 of the fixed circulation units 306a and 306b. Accordingly, ink flowing out of the collection port 328 can flow into the collection tube 24 through the flow path 922. Incidentally, the collection port 328 of the circulation unit 306a corresponding to the white ink prone to cause sedimentation communicates with the flow path 922, while the collection ports 328 of the circulation units 306b corresponding to the light magenta and light cyan inks less prone to cause sedimentation do not communicate with the flow paths 922. Thus, in the present embodiment, the collection tube 24 is connected to only the connecting portion 330 corresponding to the flow path 922 communicating with the collection port 328 of the circulation unit 306a.

The circulation units 306a and 306b are fixed to the housing unit 308 by screws 332. The supply ports 324 and the flow paths 912 are thus connected and communicate with each other. The collection ports 328 and the flow paths 922 are connected, but the collection ports 328 of the circulation units 306b do not communicate with the flow paths 922 and only the collection port 328 of the circulation unit 306a communicates with the flow path 922. As the sealing member provided on the connecting portion, an elastic member such as a rubber or elastomer is used. Since the print head 16b is configured as stated above, the print head 16b is configured to easily cope with the ability of the ejected ink to easily cause sedimentation of contained material by changing the circulation unit 306a and the circulation units 306b. In this case, the communication status between the collection port 328 and the flow path 922 and the connection of the collection tube 24 with the connecting portion 330 are changed according to the change of the circulation unit 306a and the circulation units 306b.

### Configuration of Printing Element Substrate 302

Next, the configuration of the printing element substrate 302 will be described. FIG. 4 is a cross section configuration diagram of the printing element substrate 302. The printing element substrate 302 comprises a substrate 402, an ejection opening forming member 404 which covers one surface of the substrate 402, and a cover plate 406 which covers the other surface of the substrate 402. The ejection opening forming member 404 has a pressure chamber 408 which stores ink provided with ejection energy and an ejection opening 410 through which the ink is ejected from the pressure chamber 408 to the outside by the provided ejection energy. In the ejection opening forming member 404, a plurality of ejection openings 410 are arrayed in an extending direction of the printing element substrate 302. In the pressure chamber 408, an ejection energy generating element 412 which generates ejection energy is provided as a printing element on the substrate 402 at a position facing the ejection opening 410. As the ejection energy generating element 412, a publicly-known element such as an electrothermal transducing element or piezoelectric element can be used.

In a case where an electrothermal transducing element is used, the element is heated to cause ink to bubble in the pressure chamber 408 and the bubble generating energy is used to eject ink from the ejection opening 410 communicating with the pressure chamber 408. One side of the pressure chamber 408 in a direction intersecting with the array direction of the ejection openings 410 has an inlet port 414 through which ink flows into the pressure chamber 408 and the other side of the pressure chamber 408 in that direction has an outlet port 416 through which ink flows out of the pressure chamber 408. One inlet port 414 and one outlet port 416 are arranged for one or more of the ejection openings 410.

The substrate 402 has a supply flow path 418 and a collection flow path 420 which are provided to extend in parallel with each other in the extending direction of the ejection openings 410. The inlet port 414 is connected to the supply flow path 418 and the outlet port 416 is connected to the collection flow path 420. The supply flow path 418 and the collection flow path 420 are open on the other surface of the substrate 402 and the openings are covered with the cover plate 406.

The cover plate 406 has an opening portion 422 through which the supply flow path 418 and the collection flow path 420 communicate with the outside. The supply flow path 418 is connected to the connection flow path 916 (see FIG. 9) communicating with a first bubble storage flow path 914 (see FIG. 9) to be described later through the opening portion 422. The collection flow path 420 is connected to the connection flow path 918 (see FIG. 9) communicating with a second bubble storage flow path 920 (see FIG. 9) to be described later through the opening portion 422. Incidentally, the first bubble storage flow path 914 and the second bubble storage flow path 920 are provided in the supporting member 312.

The number of opening portions through which the supply flow path 418 communicates with the outside and the number of opening portions through which the collection flow path 420 communicates with the outside may be each one or two or more. Further, the number of opening portions through which the supply flow path 418 communicates with the outside and the number of opening portions through which the collection flow path 420 communicates with the outside may be the same or one may be greater than the other. For example, nine opening portions 422 are formed in one supply flow path 418 and eight opening portions 422 are formed in one collection flow path 420.

It is preferable that the cover plate 406 be made of a material sufficiently resistant to corrosion by ink ejected from the ejection openings 410. Further, from the view point of color mixing prevention, high accuracy is required for the opening shape and position of the opening portions 422. Thus, it is preferable to use a photosensitive resin material or silicon plate as the material for the cover plate 406 and form the opening portions 422 through a photolithographic process.

### Flow Path in Printing Element Substrate 302

In the printing element substrate 302, ink supplied from the connection flow path 916 to the supply flow path 418 through the opening portion 422 flows into the pressure chamber 408 through the inlet port 414 (see arrow I in FIG. 4). The ink which has flowed into the pressure chamber 408 then flows into the collection flow path 420 through the outlet port 416 (see arrow II in FIG. 4). The ink in the collection flow path 420 is collected to the connection flow path 918 through the opening portion 422. The connection flow path 916 is connected to a first pressure control chamber 508 (see FIG. 5) controlled at a relatively-low pressure through the first bubble storage flow path 914 (see FIG. 9). The connection flow path 918 is connected to a second pressure control chamber 528 (see FIG. 5) controlled at a relatively-high pressure through the second bubble storage flow path 920 (see FIG. 9). The first pressure control chamber 508 and the second pressure control chamber 528 will be described later.

Accordingly, the supply flow path 418 connected to the connection flow path 916 is higher in pressure than the collection flow path 420 connected to the connection flow path 918. This pressure difference causes ink to flow in the directions of arrows I and II in FIG. 4 in each pressure chamber 408. This ink flow makes it possible to, for example, collect thickened ink in the ejection opening 410 in a non-printing operation and suppress thickening of ink in the ejection opening 410 which does not eject ink in a printing operation. Thus, a decrease in ink ejection performance of each ejection opening 410 can be suppressed. As described above, in the present embodiment, the printing element substrate 302 functions as an ejection section which can eject supplied liquid from the ejection openings and collect liquid not ejected from the ejection openings.

### Configuration of Circulation Unit 306

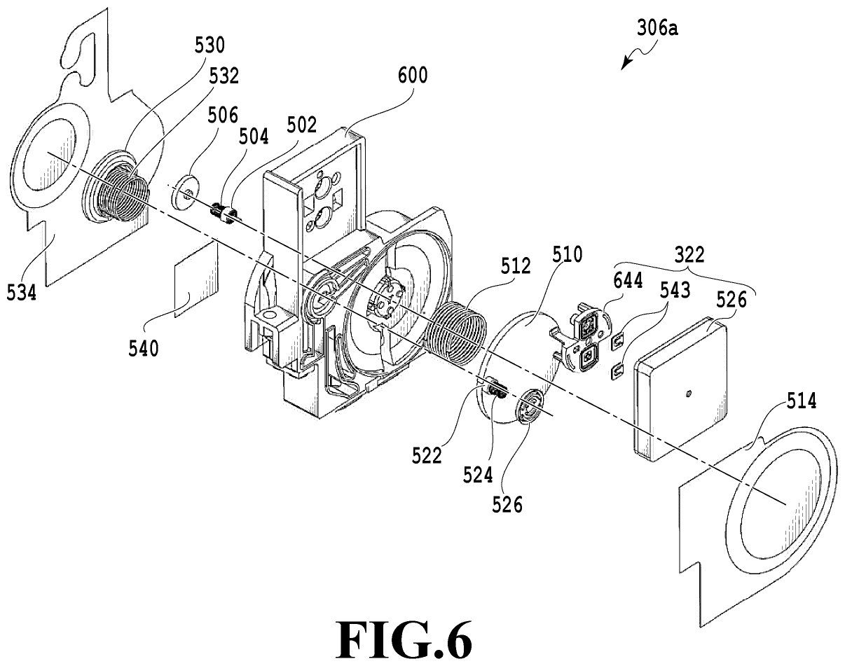

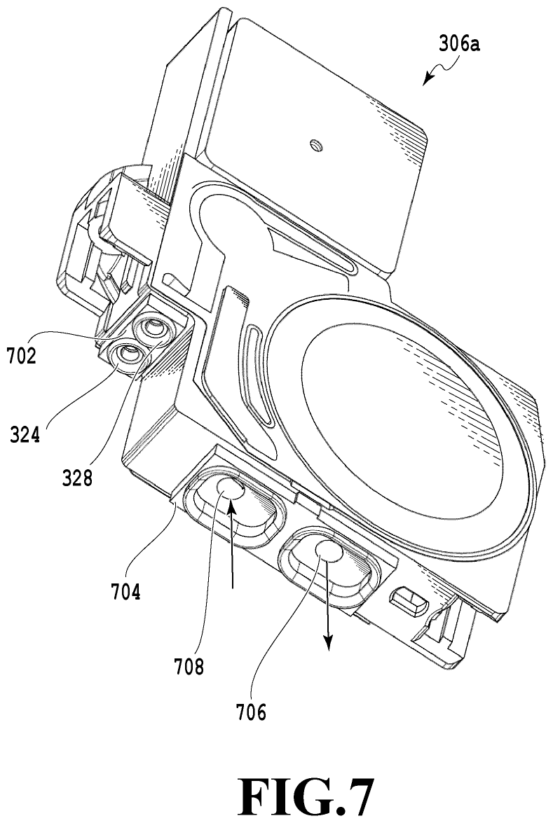

Next, the configuration of the circulation unit 306a will be described. FIG. 5 is a schematic configuration diagram of the circulation unit 306a. FIG. 6 is an exploded view of the circulation unit 306a. FIG. 7 is a perspective view of the circulation unit 306a. Incidentally, the circulation unit 306b is different from the circulation unit 306a only in that the collection port 328 of the circulation unit 306a does not communicate with the flow path 922 which communicates with the connecting portion 330 connected to the collection tube 24.

The first pressure control mechanism 320 provided in the circulation unit 306a comprises a first pressure control valve 502, a valve spring 504, and a spring bearing 506 (see FIG. 5) and these features are provided on one surface of a base section 600 (see FIG. 6). The first pressure control mechanism 320 also comprises a first pressure plate 510 arranged in the first pressure control chamber 508 and a first control spring 512 which biases the first pressure plate 510 in a direction in which the volume of the first pressure control chamber increases (see FIG. 5) and these features are provided on the other surface of the base section 600 (see FIG. 6). The first pressure control mechanism 320 further comprises a film 514 which covers the other surface of the base section 600 to thereby form a change film in part of the plurality of flow paths and the first pressure control mechanism 320 (see FIG. 6).

The second pressure control mechanism 500 provided in the circulation unit 306a comprises a second pressure control valve 522, a valve spring 524, and a spring bearing 526 (see FIG. 5) and these features are provided on the other surface of the base section 600 (see FIG. 6). The second pressure control mechanism 500 also comprises a second pressure plate 530 arranged in the second pressure control chamber 528 and a second control spring 532 which biases the second pressure plate 530 in a direction in which the volume of the second pressure control chamber 528 increases (see FIG. 5). These features are provided on the one surface of the base section 600 (see FIG. 6). The second pressure control mechanism 500 further comprises a film 534 which covers the one surface of the base section 600 to thereby form a change film in part of the plurality of flow paths and the second pressure control mechanism 500.

As described above, in the present embodiment, the first pressure control mechanism 320 and the second pressure control mechanism 500 are under a direct-acting system using wire springs, but the system is not limited to this. The first pressure control mechanism 320 and the second pressure control mechanism 500 may be control mechanisms including leaf springs or rotation operation or may be externally-controlled pressure control mechanisms.

The circulation unit 306a comprises a filter 540 in addition to the first pressure control mechanism 320, the second pressure control mechanism 500, and the circulation pump 322. Ink which has flowed from the flow path 912 passes through the filter 540 and the first pressure control mechanism 320 and flows into the first pressure control chamber 508 in which the negative pressure is controlled by the first pressure control mechanism 320. The first pressure control chamber 508 is connected to the second pressure control chamber 528 by two flow paths 542 and 544. The flow path 544 is provided with the circulation pump 322. The flow path 544 is connected to a collection flow path 924 (see FIG. 9) provided to extend to the collection port 328 between the second pressure control chamber 528 and the circulation pump 322.

The circulation pump 322 is a diaphragm pump and comprises two check valves 543, a pump connecting portion 644 (see FIG. 6) which fixes the check valves 543 to the base section 600, a piezoelectric element 526 to be a drive element, and a pump housing 527 whose volume can be changed by the piezoelectric element 526. Of the two check valves 543, one check valve 543a is provided to suck ink from the second pressure control chamber 528 and the other check valve 543b is provided to discharge ink to the first pressure control chamber 508. According to the above configuration, the volume of the pump housing 527 (see FIG. 5) is changed by applying a drive voltage to the piezoelectric element 526, the two check valves move alternately by the pressure change, and ink can be transferred from the second pressure control chamber 528 to the first pressure control chamber 508. The pump capability of the circulation pump 322 can be changed by the frequency and the voltage applied to the piezoelectric element 526.

In the printing apparatus 10, an ink circulation path (described later) including the flow paths provided in the circulation unit 306a is provided in the print head 16b, whereby the circulation path is downsized and the pump capability necessary for stable ink ejection from the ejection opening 410 can be reduced. Accordingly, the circulation pump 322 can be downsized, which results in downsizing of the print head 16 and enables high-speed printing.

In the printing apparatus 10, the first pressure control mechanism 320 and the second pressure control mechanism 500 function so that the pressure difference between the first pressure control chamber 508 and the second pressure control chamber 528 is kept constant. As a result, in the printing apparatus 10, ink can be stably ejected while ink is circulated through the circulation path including the flow paths in the circulation unit 306a and printing element substrate 302. This enables suppression of thickening of ink in the ejection opening 410 which does not eject ink in a printing operation, for example.

The second pressure control mechanism 500 can produce a negative pressure in the second pressure control chamber 528 by application of a reaction force of the second control spring 532 to the film 534 via the second pressure plate 530. The second pressure control mechanism 500 can also adjust a valve opening pressure of the second pressure control valve 522 by adjusting a spring coefficient of the second control spring 532, a spring coefficient of the valve spring 524, and a set pressure of the first pressure control chamber 508.

In a case where ink is collected from the second pressure control chamber 528 by the circulation pump 322 and the pressure inside the second pressure control chamber 528 becomes equal to or less than the valve opening pressure of the second pressure control valve 522, the second pressure control valve 522 opens an orifice 546. This allows ink to flow from the first pressure control chamber 508 into the second pressure control chamber 528 through the flow path 542. In a case where the pressure inside the second pressure control chamber 528 exceeds the valve opening pressure of the second pressure control valve 522 due to the inflow of ink from the first pressure control chamber 508 through the flow path 542, the second pressure control valve 522 closes the orifice 546 and the second pressure control chamber 528 returns to a set negative pressure.

According to the above operation, even in a case where the amount of ink circulating between the circulation unit 306a and the printing element substrate 302 connected via the connection flow path 918 and the like is changed, the negative pressure of the second pressure control chamber 528 can be kept at the set negative pressure.

The first pressure control mechanism 320 can produce a negative pressure in the first pressure control chamber 508 by application of a reaction force of the first control spring 512 to the film 514 via the first pressure plate 510. The first pressure control mechanism 320 can also adjust a valve opening pressure of the first pressure control valve 502 by adjusting a spring coefficient of the first control spring 512, a spring coefficient of the valve spring 504, and a pressure for supplying ink to the first pressure control chamber 508. The pressure for supplying ink to the first pressure control chamber 508 is a pressure in consideration of a pressure of the pump 904 applied to the flow path guiding ink flowing out of the filter 540 into the first pressure control mechanism 320 and a pressure loss by the ink flow in the supply tube 22 and the filter 540.

In a case where ink flows from the first pressure control chamber 508 into the second pressure control chamber 528 through the flow path 542 and the pressure inside the first pressure control chamber 508 becomes equal to or less than the valve opening pressure of the first pressure control valve 502, the first pressure control valve 502 opens an orifice 548. This allows ink supplied through the filter 540 to flow into the first pressure control chamber 508. In a case where the pressure inside the first pressure control chamber 508 exceeds the valve opening pressure of the first pressure control valve 502 due to the inflow of ink into the first pressure control chamber 508, the first pressure control valve 502 closes the orifice 548 and the first pressure control chamber 508 returns to a set negative pressure.

In a case where ink is ejected from the ejection opening 410, the amount of ink is reduced in the circulation path including the flow paths in the printing element substrate 302 and the circulation unit 306a and the negative pressure in the entire circulation path is increased (in other words, the pressure is decreased). Since the amount of ink collected by the second pressure control mechanism 500 is changed according to a differential pressure between the first pressure control chamber 508 and the second pressure control chamber 528, the second pressure control mechanism 500 does not make a contribution to pressure control in the circulation path. Accordingly, ink ejected from the ejection opening 410 is subjected to pressure regulation in the circulation path such that inflow of ink supplied through the filter 540 is caused by the first pressure control mechanism 320 and ink can be thereby stably ejected from the ejection opening 410.

A sealing member 702 is arranged in the connecting portion between the circulation unit 306a and the flow paths 912 and 922 provided in the housing unit 308 (see FIG. 7). A sealing member 704 is provided in the connecting portion between the circulation unit 306a and the first bubble storage flow path 914 and second bubble storage flow path 920 (see FIG. 7). These sealing members 702 and 704 are joined by two-color elastomer molding. The sealing members 702 and 704 may be made of a rubber member such as EPDM.

### Ink Flow in Circulation Unit 306a

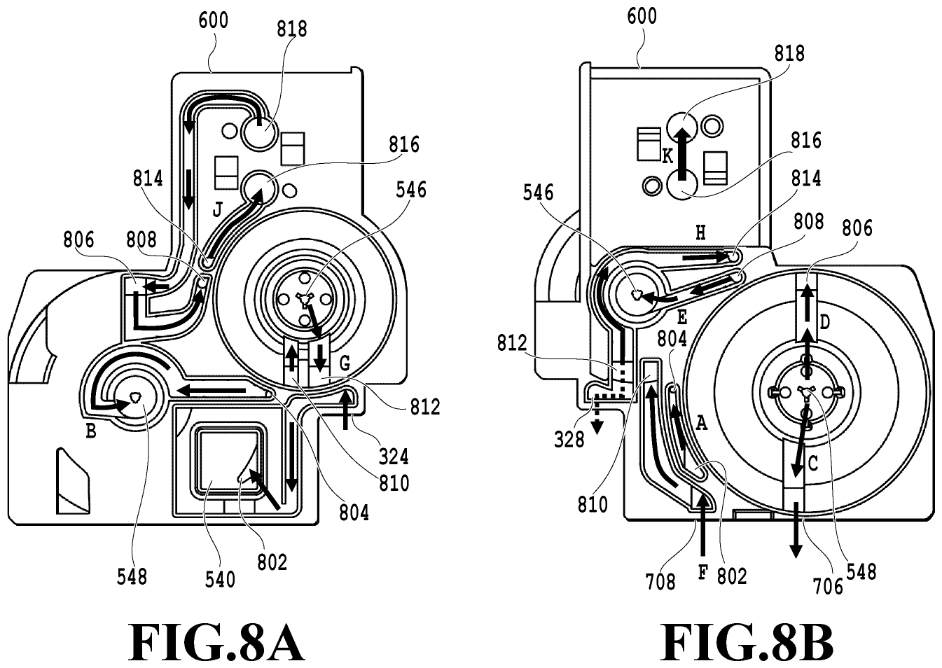

Next, ink flow in the circulation unit 306a will be described. It is assumed that the ink flow in the circulation unit 306a described here is ink flow in first circulation to be described later. FIGS. 8A and 8B are diagrams illustrating the ink flow in the circulation unit 306a. FIG. 8A shows one surface of the base section 600 and FIG. 8B shows the other surface of the base section 600. In the circulation unit 306a, a flow path through which ink is circulated is formed by grooves formed in the one surface and the other surface of the base section 600 and the films 514 and 534. Portions subjected to a spring reaction force and the like are reinforced with members such as the first pressure plate 510, the second pressure plate 530, and the spring bearings 506 and 526.

In the printing apparatus 10, the circulation unit 306a comprising the circulation pump 322, the first pressure control mechanism 320, and the second pressure control mechanism 500 is mounted on the print head 16b to downsize the ink circulation mechanism. This enables stable ink ejection while suppressing ink thickening even in a large-scale apparatus such as a large-format printer.

In the circulation unit 306a, the flow paths formed in the one surface and the other surface of the base section 600 are connected so that they penetrate the base section 600 for the purpose of downsizing. More specifically, ink flowing from the supply port 324 passes through the filter 540 provided on the one surface of the base section 600 and flows to the other surface of the base section 600 through a through hole 802. After passing through the through hole 802 and flowing into the flow path provided in the other surface, the ink flows to the one surface through a through hole 804 (see arrow A) and then flows to the other surface through the orifice 548 (see arrow B). After flowing to the other surface through the orifice 548, the ink flows out of the circulation unit 306a (see arrow C) through the outlet port 706 (see FIG. 7) and then flows toward the first bubble storage flow path 914. The ink which has flowed to the other surface through the orifice 548 also flows to the one surface through a through hole 806 (see arrow D) and then flows to the other surface through a through hole 808.

After flowing to the other surface through the through hole 808, the ink flows to the one surface through the orifice 546 (see arrow E). In the other surface, the ink which has flowed from the second bubble storage flow path 920 (see arrow F) through the inlet port 708 (see FIG. 7) flows to the one surface through a through hole 810 and is merged with the ink which has flowed to the one surface through the orifice 546. After that, the merged ink flows to the other surface through a through hole 812 (see arrow G) and then flows out of the circulation unit 306a through the collection port 328 (see the broken line arrow) and also flows to the one surface through a through hole 814 (see arrow H). The ink which has flowed to the one surface through the through hole 814 flows to the other surface through a through hole 816 provided with one check valve 543a (see arrow J) and then flows to the one surface through a through hole 818 provided with the other check valve 543b (see arrow K).

The filter 540 traps and collects dust included in ink flowing from the supply port 324 to suppress clogging of the flow paths provided in the circulation unit 306a and the printing element substrate 302. In the through holes 816 and 818, the check valves 543a and 543b are arranged on the other surface through the pump connecting portion 644. As the pressure regulating function of the first pressure control mechanism 320 and the second pressure control mechanism 500, the stability of opening/closing of the pressure control valves 502 and 522 and the stable ink collection function of the orifices 546 and 548 are important.

### Ink Circulation Path

Next, an ink circulation path in the printing apparatus 10 will be described. FIG. 9 is a diagram illustrating the ink circulation path provided in the printing apparatus 10. In the printing apparatus 10, the ink supply unit 20 and the print head 16b are connected to each other by the supply tube 22 and the collection tube 24 to form a circulation path through which ink can be circulated between the ink supply unit 20 and the print head 16b.

In the ink supply unit 20, the ink tank 18 is connected to the supply tube 22 through a supply path 902. The supply path 902 is provided with the pump 904 which can transfer ink stored in the ink tank 18 to the supply tube 22. The supply path 902 is also provided with a supply valve 906 openable and closable between the pump 904 and the ink tank 18. While the supply valve 906 is open, ink stored in the ink tank 18 can be transferred to the supply tube 22 through the supply path 902 by driving of the pump 904. In contrast, while the supply valve 906 is closed, even in a case where the pump 904 is driven, ink stored in the ink tank 18 cannot be transferred to the supply tube 22 through the supply path 902. In this manner, the ink supply unit 20 is configured such that the supply valve 906 permits and prohibits transfer of ink from the ink tank 18 to the supply tube 22.

The ink supply unit 20 also comprises a collection path 908 which guides ink flowing therein from the collection tube 24 to the supply path 902. The collection path 908 is connected to the supply path 902 between the pump 904 and the supply valve 906. The collection path 908 is provided with a collection valve 910. While the collection valve 910 is open, ink flowing into the collection path 908 can be guided to the supply path 902. While the collection valve 910 is closed, ink cannot be guided to the supply path 902 through the collection path 908. In this manner, the ink supply unit 20 is configured such that the collection valve 910 permits and prohibits ink inflow through the collection tube 24 and the like.

Ink supplied through the supply tube 22 flows into the circulation unit 306a through the flow path 912 provided in the housing unit 308 and then flows into the first pressure control chamber 508 comprising the first pressure control mechanism 320 through the filter 540. The ink which has flowed into the first pressure control chamber 508 then flows into the second pressure control chamber 528 comprising the second pressure control mechanism 500 through the flow path 542. The ink which has flowed into the first pressure control chamber 508 also flows into the first bubble storage flow path 914 through the outlet port 706 and then flows into the printing element substrate 302 through the connection flow path 916. In the printing element substrate 302, the ink flows from the opening portion 422 to the connection flow path 918 through the supply flow path 418, the inlet port 414, the pressure chamber 408, the outlet port 416, and the collection flow path 420.

The ink which has flowed into the connection flow path 918 passes through the second bubble storage flow path 920, flows into the circulation unit 306a through the inlet port 708, and flows into the second pressure control chamber 528. The ink in the second pressure control chamber 528 can flow into the first pressure control chamber 508 through the flow path 544. The flow path 544 comprises a collection flow path 924 connected to the flow path 922 which communicates with the connecting portion 330 through the collection port 328 between the circulation pump 322 and the second pressure control chamber 528. Accordingly, the ink in the second pressure control chamber 528 can be collected to the ink supply unit 20 through the collection flow path 924, the flow path 922, and the collection tube 24 by driving of the pump 904. As described above, in the present embodiment, the ink supply unit 20 functions as a supply section which can supply liquid stored in the ink tank 18 to the first pressure control chamber 508 and collect ink from the first pressure control chamber 508, the second pressure control chamber 528, and the printing element substrate 302.

### Configuration of Control System of Printing Apparatus

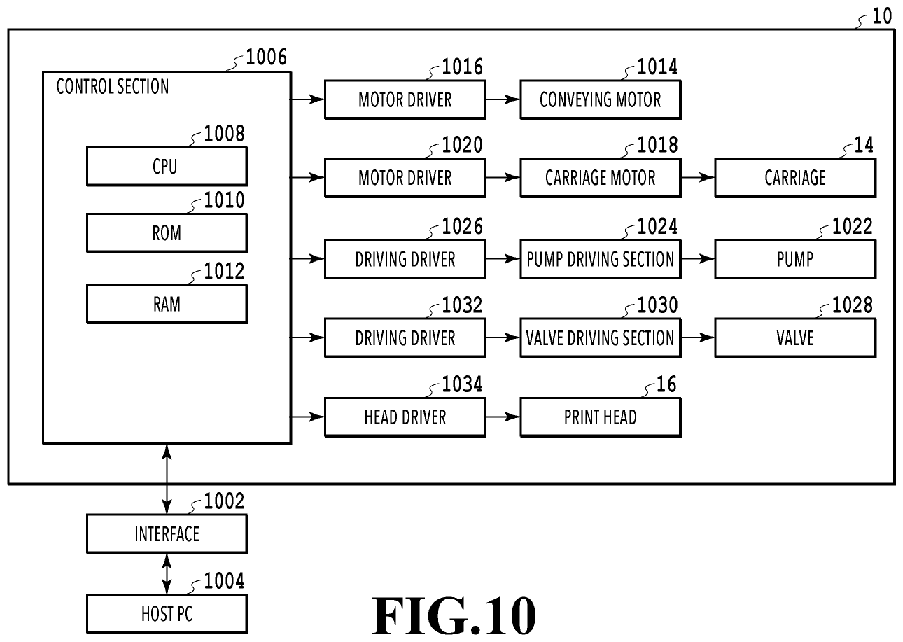

Next, a configuration of a control system of the printing apparatus 10 will be described. FIG. 10 is a block diagram showing the configuration of the control system of the printing apparatus.

The printing apparatus 10 is connected to a data supply apparatus such as a host computer (hereinafter referred to as “host PC”) 1004 via an interface 1002. Various types of data transmitted from the host PC 1004, control signals related to various processes executed in the printing apparatus 10, and the like are input to a control section 1006. The control section 1006 comprises a CPU 1008 which executes various control programs and a ROM 1010 which stores the control programs executed by the CPU 1008 and the like. The control section 1006 also comprises a RAM 1012 which stores various types of data such as input image data, multivalued gradation data of an intermediate product, a multipath mask, and a program control variable, and is used as a work area of the CPU 1008.

The printing apparatus 10 comprises a motor driver 1016 which drives a conveying motor 1014. Incidentally, a print medium M is conveyed in the Y direction (see FIG. 1) by driving of the conveying motor 1014. The motor driver 1016 is controlled by the CPU 1008, whereby the CPU 1008 controls driving of the conveying section via the motor driver 1016. The printing apparatus 10 also comprises a motor driver 1020 for driving a carriage motor 1018 which moves the carriage 14 in the X direction (see FIG. 1). The motor driver 1020 is controlled by the CPU 1008, whereby the CPU 1008 controls movement of the carriage 14 (print head 16) via the motor driver 1020.

The printing apparatus 10 comprises a driving driver 1026 for driving a pump driving section 1024 for driving a pump 1022. In the description with reference to FIG. 10, the circulation pump 322 and the pump 904 are shown as the pump 1022 to facilitate understanding. The driving driver 1026 is controlled by the CPU 1008, whereby the CPU 1008 controls driving of the circulation pump 322 and the pump 904. The printing apparatus 10 also comprises a driving driver 1032 for driving a valve driving section 1030 for driving a valve 1028. In the description with reference to FIG. 10, the supply valve 906 and the collection valve 910 are shown as the valve 1028 to facilitate understanding. The driving driver 1032 is controlled by the CPU 1008, whereby the CPU 1008 controls driving of the supply valve 906 and the collection valve 910. The printing apparatus 10 further comprises a head driver 1034 which drives the print head 16. The head driver 1034 is controlled by the CPU 1008, whereby the print heads 16a and 16b are subjected to various types of control such as ink ejection timing control by the CPU 1008.

### First Circulation

In the ink circulation path described above, during a printing operation, the printing apparatus 10 executes first circulation in which ink is circulated so that ink can be stably ejected from the ejection opening 410 and ink thickening is suppressed in the ejection opening 410 which does not eject ink. However, the first circulation is not limited to the execution during a printing operation. For example, in order to eliminate ink thickening in the ejection openings 410 in a non-printing operation, the first circulation may be executed at a predetermined timing such as a timing at which a certain period elapses without execution of a new printing operation after the latest printing operation. Incidentally, the first circulation is executed in the print head 16a and the print head 16b.

In the first circulation, the CPU 1008 first opens the supply valve 906 to allow the supply path 902 to communicate with the ink tank 18 and closes the collection valve 910 to prevent the supply path 902 from communicating with the collection path 908 (see FIG. 9). Next, the CPU 1008 drives the pump 904 to transfer ink stored in the ink tank 18 to the print head 16b through the supply tube 22. The subsequent ink flow will be described with reference to the arrows in FIG. 9.

The ink transferred to the print head 16b passes through the flow path 912 and the filter 540 and is then supplied to the first pressure control mechanism 320 and the first pressure control chamber 508. By this ink supply, the first pressure control mechanism 320 adjusts the pressure inside the first pressure control chamber 508 to a predetermined pressure (negative pressure). That is, the first pressure control mechanism 320 controls the pressure inside the first pressure control chamber 508 so that it is a first negative pressure. The CPU 1008 also drives the circulation pump 322 to transfer ink from the second pressure control chamber 528 to the first pressure control chamber 508 through the flow path 544. By this ink transfer by the circulation pump 322, the second pressure control mechanism 500 adjusts the pressure inside the second pressure control chamber 528 to a pressure lower than the pressure inside the first pressure control chamber 508. That is, the second pressure control mechanism 500 adjusts the pressure inside the second pressure control chamber 528 to a second negative pressure which indicates the pressure lower than the above first negative pressure, namely the second negative pressure which indicates a negative pressure value higher than that of the first negative pressure.

Accordingly, the negative pressure in the supply flow path connected to the first pressure control chamber 508 for supply to the pressure chamber 408 is lower than that in the collection flow path connected to the second pressure control chamber 528 for collection from the pressure chamber 408, thereby producing ink flow from the supply flow path to the collection flow path through the pressure chamber 408. Incidentally, the supply flow path to the pressure chamber 408 includes the first bubble storage flow path 914, the connection flow path 916, the opening portion 422, the supply flow path 418, and the inlet port 414. The collection flow path from the pressure chamber 408 includes the outlet port 416, the collection flow path 420, the opening portion 422, the connection flow path 918, and the second bubble storage flow path 920. The first bubble storage flow path 914 and the second bubble storage flow path 920 each have a capacity capable of temporarily storing bubbles produced in circulating ink.

Thus, in the first circulation, ink flow from the first pressure control chamber 508 to the pressure chamber 408 through the first bubble storage flow path 914, the connection flow path 916, and the supply flow path 418 is produced. Ink flow from the pressure chamber 408 to the second pressure control chamber 528 through the collection flow path 420, the connection flow path 918, and the second bubble storage flow path 920 is also produced. Further, ink flow from the first pressure control chamber 508 to the second pressure control chamber 528 through the flow path 542 is produced. In a case where the ink circulating through the circulation path is ejected from the ejection opening 410 to the outside and the pressure inside the circulation path decreases, ink supplied from the supply tube 22 through the filter 540 flows into the first pressure control chamber 508. Incidentally, the flow path 544 is connected to the collection flow path 924 which communicates with the collection port 328 between the circulation pump 322 and the second pressure control chamber 528. However, in the first circulation, the collection valve 910 is closed in the collection path 908 connected to the collection flow path 924 through the collection tube 24. Thus, ink does not flow into the collection flow path 924, the collection tube 24, or the collection path 908. As described above, in the present embodiment, in the first circulation, the control section 1006 (CPU 1008) functions as a circulation control section which can control ink circulation between the first pressure control chamber 508, the second pressure control chamber 528, and the printing element substrate 302.

In the first circulation, ink in an ejection opening 410 which does not eject ink and a pressure chamber 408 communicating with that ejection opening 410 is collected through the collection flow path 420 by the aforementioned ink flow. This makes it possible to suppress thickening of ink caused by evaporation of a liquid component in ink from the ejection opening 410. Further, in the first circulation, even in a case where bubbles and thickened ink are produced in the pressure chamber 408 and the ejection opening 410, they are collected together with circulating ink. Accordingly, the thickened ink and bubbles flow into the flow paths and pressure control chambers in the circulation path. Since the circulation path stores a larger amount of ink than the thickened ink, the viscosity is made uniform to the extent that ejection is not affected. Further, bubbles are stored in the first bubble storage flow path 914, the second bubble storage flow path 920, the first pressure control chamber 508, and the second pressure control chamber 528 by a buoyant force to maintain a state not affecting ink ejection from the ejection opening 410.

The execution of the first circulation can reduce the necessity of execution of preliminary ejection, which is ejection of ink not contributing to printing in order to suppress ink thickening in the pressure chamber 408 and the ejection opening 410, and reduce an ink consumed amount. In addition, since the pressure of the supply flow path 418 and the collection flow path 420 is controlled in the printing element substrate 302, ink can be stably supplied to the pressure chamber 408 and ink ejection from the ejection opening 410 can be stably performed.

### Second Circulation

For example, in the case of the white ink prone to cause sedimentation, the first circulation can suppress sedimentation in some flow paths of the circulation path through which ink is continuously circulated. In the ink tank 18 storing the white ink, created sedimentation can be eliminated by causing a user to detach the ink tank 18 and shake it by hand for agitation or giving an agitation capability to the ink tank 18. However, in the first circulation, ink occasionally does not flow through the flow path connecting the ink tank 18 with the first pressure control mechanism 320. In this case, there is a possibility that sedimentation of the material (more specifically, a pigment) contained in the white ink is created in this flow path. In addition, in a case where a period during which the ink circulation in the circulation path is stopped due to the power-off of the printing apparatus 10 or the like exceeds a predetermined period, there is a possibility that sedimentation of the material contained in the white ink is created in the circulation path.

In order to eliminate the created sedimentation by using the first circulation, for example, it is considered that the sedimentation is eliminated by increasing the pump frequency of the circulation pump 322, increasing the flow rate of circulating ink, and agitating the inside of the flow path by the produced ink flow. However, in the circulation path, the first pressure control mechanism 320 and the second pressure control mechanism 500 controls the first pressure control chamber 508 and the second pressure control chamber 528 to have a predetermined pressure difference. Accordingly, in the flow path from the first pressure control chamber 508 to the second pressure control chamber 528 through the printing element substrate 302, there is a possibility that the ink flow velocity is not increased and the created sedimentation is not eliminated by the ink flow. Incidentally, in the flow path of circulation through the first pressure control chamber 508, the flow path 542, the second pressure control chamber 528, and the flow path 544, the ink flow velocity can be increased by increasing the pump frequency of the circulation pump 322. Thus, in this flow path, the created sedimentation can be eliminated by the ink flow.

Therefore, the present embodiment executes second circulation which enables elimination of sedimentation created in the flow path connecting the ink supply unit 20 with the first pressure control chamber 508 and the flow path from the first pressure control chamber 508 to the second pressure control chamber 528 through the printing element substrate 302. Incidentally, the flow path connecting the ink supply unit 20 with the first pressure control chamber 508 is specifically a flow path from the supply path 902 to the first pressure control mechanism 320 through the supply tube 22, the flow path 912, the supply port 324, the filter 540, and the like. The flow path from the first pressure control chamber 508 to the second pressure control chamber 528 through the printing element substrate 302 is specifically a flow path to the second pressure control chamber 528 through the first bubble storage flow path 914, the flow paths in the printing element substrate 302, the second bubble storage flow path 920, and the like. The second circulation will be described below in detail.

The printing apparatus 10 executes the second circulation at a predetermined timing at which a long period elapses without execution of a printing operation. The predetermined timing at which a long period elapses without execution of a printing operation is, for example, a timing at which sedimentation is created in the ink prone to cause sedimentation to the extent that it can be eliminated by the second circulation. More specifically, for example, the timing is set such that a period that has elapsed since the latest printing operation was finished is longer than a period necessary for creation of sedimentation in the ink prone to cause sedimentation and is shorter by a certain period than a period that makes it impossible to eliminate the created sedimentation by the second circulation. Incidentally, since the collection flow path 924 is used in the second circulation, the second circulation cannot be executed in the print head 16a. Accordingly, the second circulation is executed only in the circulation path including the flow paths in the circulation unit 306a of the print head 16b.

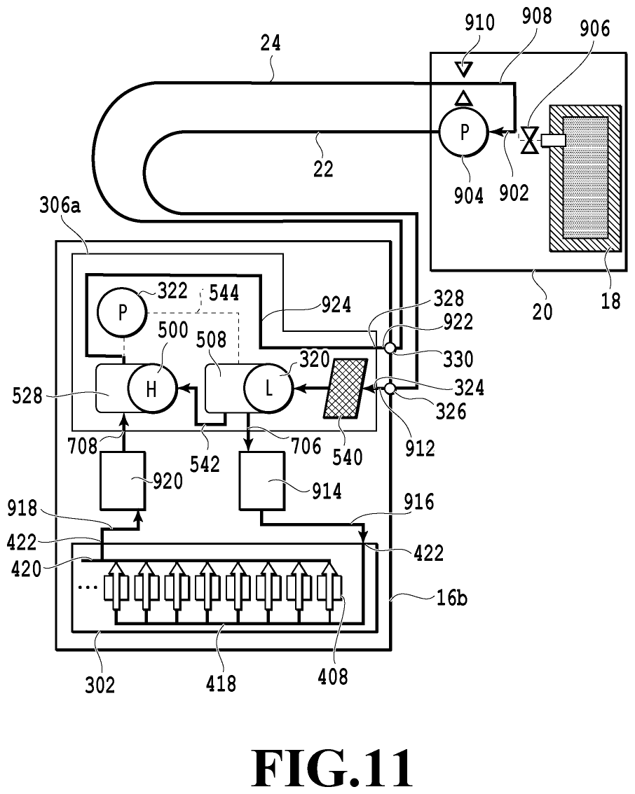

In the second circulation, the CPU 1008 first closes the supply valve 906 to prevent the supply path 902 from communicating with the ink tank 18 and opens the collection valve 910 to allow the supply path 902 to communicate with the collection path 908 (see FIG. 11). FIG. 11 is a diagram illustrating the ink flow in the second circulation. Thus, ink stored in the ink tank 18 is prevented from flowing into the circulation path even in a case where the pump 904 is driven. Next, the CPU 1008 drives the pump 904 to start ink circulation. Here, on the upstream side of the pump 904 (the upstream side in the direction of ink flow by the pump 904), the collection path 908 is connected to the supply path 902 and the collection valve 910 in the collection path 908 is open. Further, on the upstream side of the pump 904, the ink tank 18 is connected to the supply path 902 and the supply valve 906 in the supply path 902 is closed. Accordingly, even in a case where the pump 904 is driven, ink stored in the ink tank 18 does not flow into the circulation path. Further, by driving of the pump 904, ink is sucked from the second pressure control chamber 528 through the collection flow path 924, the collection tube 24, and the collection path 908 and the ink sucked into the collection path 908 is transferred to the print head 16b through the supply tube 22.

The ink transferred to the print head 16b passes through the flow path 912 and the filter 540 and is then supplied to the first pressure control mechanism 320 and the first pressure control chamber 508. The ink in the first pressure control chamber 508 flows into the second pressure control chamber 528 through the first bubble storage flow path 914, the connection flow path 916, the supply flow path 418, the pressure chamber 408, the collection flow path 420, the connection flow path 918, and the second bubble storage flow path 920. The ink in the first pressure control chamber 508 also flows into the second pressure control chamber 528 through the flow path 542 and the second pressure control mechanism 500.

The ink in the second pressure control chamber 528 flows into the collection path 908 through the collection flow path 924 and the collection tube 24 by driving of the pump 904 and the inflow of ink from the pressure control chamber 508. The ink which has flowed into the collection path 908 then flows into the supply tube 22 through the supply path 902. As a result, ink is circulated between the ink supply unit 20 and the print head 16b. In this manner, in the present embodiment, in the second circulation, the control section 1006 (CPU 1008) functions as a circulation control section which can control ink circulation among the first pressure control chamber 508, the second pressure control chamber 528, the printing element substrate 302, and the ink supply unit 20.

As described above, in the second circulation, ink is collected from the second pressure control chamber 528 through the collection path 908, the collection tube 24, and the collection flow path 924 by driving of the pump 904. In the second circulation, a negative pressure value applied to the second pressure control chamber 528 by the pump 904 is greater than that applied to the second pressure control chamber 528 by the circulation pump 322 in the first circulation. Accordingly, the flow velocity of ink flowing from the first pressure control chamber 508 into the printing element substrate 302 through the first bubble storage flow path 914 and the like and then flowing from the printing element substrate 302 into the second pressure control chamber 528 through the second bubble storage flow path 920 and the like is greater than that in the first circulation. The flow velocity of ink flowing from the first pressure control chamber 508 to the second pressure control chamber 528 through the flow path 542 is also greater than that in the first circulation. Thus, the second circulation can eliminate sedimentation created in the flow path from the first pressure control chamber 508 to the second pressure control chamber 528 through the flow paths in the printing element substrate 302 and the like, which cannot be eliminated in the first circulation even by increasing the pump frequency of the circulation pump 322. In addition, even sedimentation that can be eliminated in the first circulation can be eliminated within a shorter time in the second circulation. Moreover, in the second circulation, since ink is circulated through the flow path from the ink supply unit 20 to the first pressure control mechanism 320, through which ink is not circulated in the first circulation, sedimentation can be eliminated also in this flow path.

In the second circulation, the flow velocity of ink in the flow path through the first bubble storage flow path 914, the connection flow path 916, the supply flow path 418, the pressure chamber 408, the collection flow path 420, the connection flow path 918, and the second bubble storage flow path 920 can be greater than that in the first circulation. Further, the flow velocity of ink in the flow path through the first pressure control chamber 508, the flow path 542, and the second pressure control mechanism 500 can also be greater than that in the first circulation. Therefore, the second circulation can eliminate sedimentation created in these flow paths more reliably than the first circulation. In the second circulation, ink can be circulated also in the flow path from the ink supply unit 20 to the first pressure control mechanism 320. Accordingly, the second circulation enables elimination of sedimentation created in the flow path which cannot be eliminated in the first circulation.

### Effect and Advantage

In the present embodiment, the print head 16b is configured such that ink supplied from the ink supply unit is circulated among the first pressure control chamber and the second pressure control chamber which are adjusted to negative pressure with a predetermined pressure difference and the flow paths formed in the printing element substrate. Further, the supply path to supply ink from the ink tank to the supply tube is connected to the collection path into which ink collected through the collection tube 24 flows such that ink is circulated through the circulation path including these flow paths. In a printing operation, the first circulation is executed to circulate ink through the print head 16b so that the pressure difference between the first pressure control chamber and the second pressure control chamber is maintained while ink necessary for ejection is supplied. In a case where a period during which a printing operation is not executed exceeds a predetermined period, the second circulation is executed to supply ink to the first pressure control chamber while collecting ink from the second pressure control chamber and circulate ink at a higher flow velocity than in the first circulation. The printing apparatus 10 thus can eliminate sedimentation of contained material of ink created in the circulation path while suppressing ink thickening and enabling stable ink ejection.

### Second Embodiment

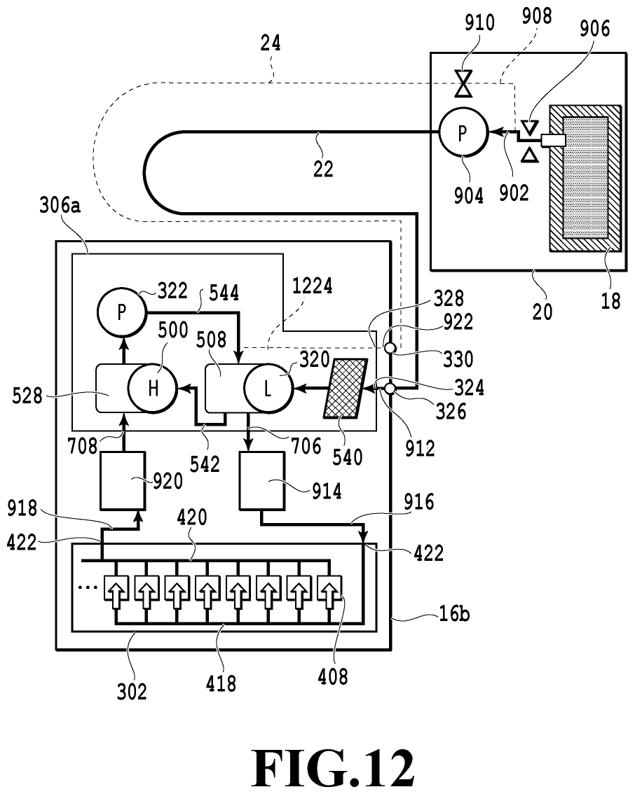

Next, a liquid ejection head according to a second embodiment will be described with reference to FIGS. 12 to 14B. In the following description, features identical or corresponding to those of the printing apparatus described above in the first embodiment are denoted by the same reference numerals as those used in the first embodiment and detailed description thereof is omitted.

The printing apparatus 10 according to the second embodiment is different from that of the first embodiment in that the collection flow path to collect ink from the flow path 544 is connected between the circulation pump 322 and the first pressure control chamber 508 in the circulation unit 306a.

FIG. 12 is a diagram illustrating an ink circulation path provided in the printing apparatus 10 according to the second embodiment. The second embodiment comprises a collection flow path 1224 which establishes communication between the flow path 544 and the collection port 328 and guides ink from the flow path 544 to the collection tube 24. The collection flow path 1224 is provided so that the flow path 544 and the collection port 328 communicate with each other between the circulation pump 322 and the first pressure control chamber 508 in the flow path 544. Since the other features of the printing apparatus 10 and the first circulation (see the arrows in FIG. 12) in the present embodiment are identical to those in the first embodiment, the following description describes in detail second circulation different from that in the first embodiment.

### Second Circulation

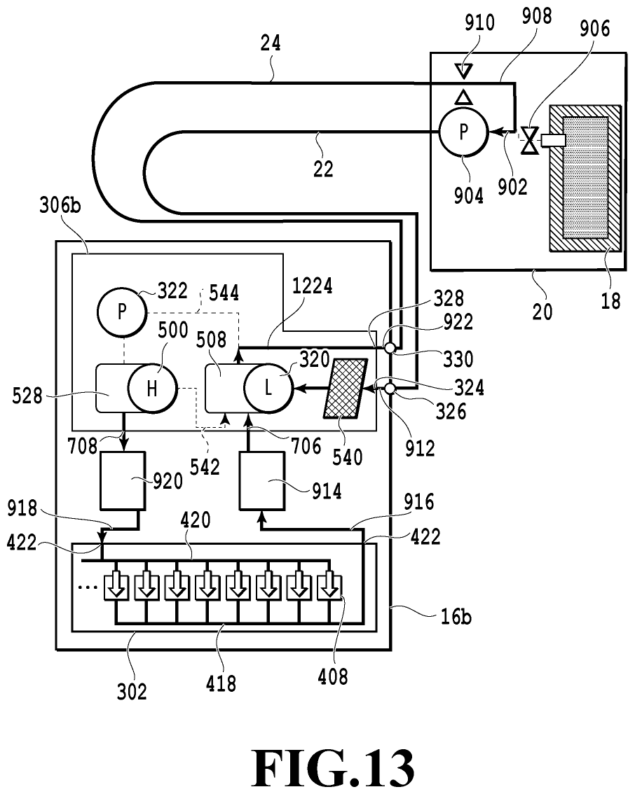

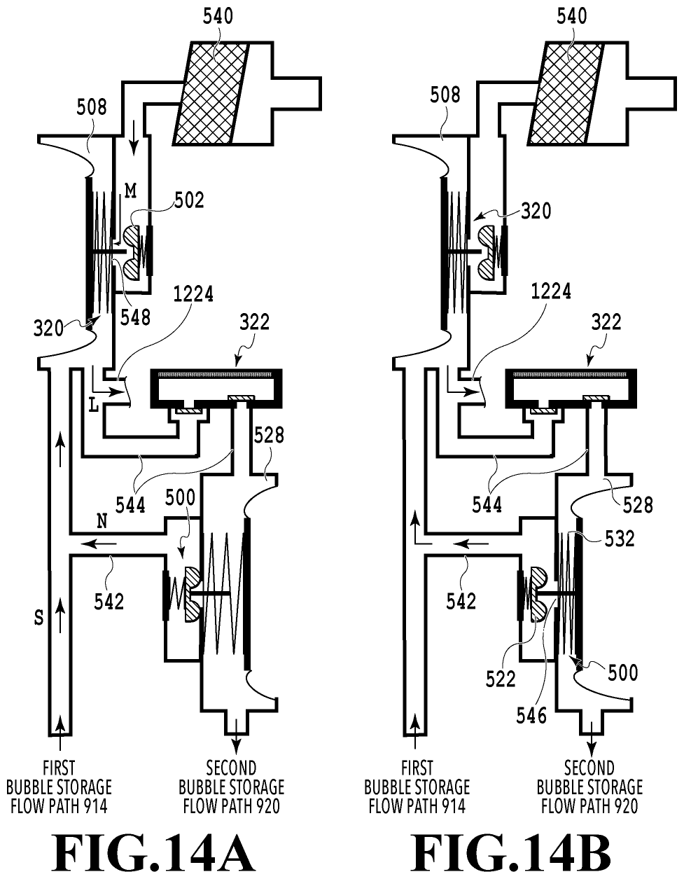

FIG. 13 is a diagram illustrating second circulation in the printing apparatus 10 according to the second embodiment. FIGS. 14A and 14B are diagrams illustrating the ink flow in the circulation unit 306a. In the second circulation, the CPU 1008 first closes the supply valve 906 to prevent the supply path 902 from communicating with the ink tank 18 and opens the collection valve 910 to allow the supply path 902 to communicate with the collection path 908. Thus, ink stored in the ink tank 18 is prevented from flowing into the circulation path even in a case where the pump 904 is driven. Next, the CPU 1008 drives the pump 904 to start ink circulation. By driving of the pump 904 and execution of ink circulation, the first pressure control chamber 508 has a higher negative pressure (lower pressure) than that of the second pressure control chamber 528 in the circulation path. In the present embodiment, by driving the pump 904 and starting ink circulation, ink is collected from the first pressure control chamber 508 to the ink supply unit 20 through the collection flow path 1224. Accordingly, in the circulation path, the first pressure control chamber 508 has a higher negative pressure (lower pressure) than that of the second pressure control chamber 528 and ink flow is produced in a direction opposite to the first circulation (see the arrows in FIG. 13).

More specifically, in a case where the pump 904 is driven, ink in the first pressure control chamber 508 flows into the collection tube 24 through the flow path 544, the collection flow path 1224, and the like (see arrow L in FIG. 14A). As a result, the first pressure control chamber 508 becomes lower in pressure than the second pressure control chamber 528. In a case where the pressure inside the first pressure control chamber 508 reaches the valve opening pressure of the first pressure control valve 502, the first pressure control valve 502 opens the orifice 548 (see FIG. 14A). Thus, ink supplied through the supply tube 22 flows into the first pressure control chamber 508 through the filter 540 and the first pressure control mechanism 320 (see arrow M in FIG. 14A).

The first pressure control chamber 508 is connected to the second pressure control chamber 528 through the second pressure control mechanism 500 and the flow path 542 and connected to the flow paths of the printing element substrate 302 through the first bubble storage flow path 914 and the connection flow path 916. Accordingly, in a case where the pressure inside the first pressure control chamber 508 becomes lower than the pressure inside the second pressure control chamber 528, ink flows from these flow paths toward the first pressure control chamber 508 (see arrows N and S in FIG. 14A). That is, ink flows toward the first pressure control chamber 508 through the second pressure control mechanism 500 and the flow path 542 (see arrow N in FIG. 14A). Further, ink flows from the second pressure control chamber 528 toward the first pressure control chamber 508 through the second bubble storage flow path 920, the connection flow path 918, the collection flow path 420, the pressure chamber 408, the supply flow path 418, the connection flow path 916, and the first bubble storage flow path 914 (see arrows in FIG. 13).

In a case where such an amount of ink as to reach the valve opening pressure of the second pressure control valve 522 of the second pressure control mechanism 500 flows from the flow path 542 toward the first pressure control chamber 508, the second pressure control valve 522 opens the orifice 546 (see FIG. 14B). Accordingly, ink flows from the second pressure control chamber 528 into the first pressure control chamber 508 through the orifice 546 and the pressure inside the second pressure control chamber 528 becomes substantially equal to the pressure inside the first pressure control chamber 508. In a case where the first pressure control chamber 508 and the second pressure control chamber 528 become substantially equal in pressure, ink stops flowing from the second pressure control chamber 528 toward the flow path 542 and the second bubble storage flow path 920. Ink is circulated only through the first pressure control mechanism 320, the first pressure control chamber 508, the collection flow path 1224, the collection tube 24, the collection path 908, the supply path 902, the supply tube 22, and the filter 540. This circulation enables elimination of sedimentation in the flow path from the supply path 902 to the first pressure control chamber 508, for example, removal of sediment in the supply tube 22, the connecting portion 326, the first pressure control valve 502, and the orifice 548.

Incidentally, the amount of ink flowing from the second pressure control chamber 528 toward the flow path 542 and the second bubble storage flow path 920 corresponds to the volume of the second pressure control chamber 528 in a case where the second control spring 532 expands. Thus, the volume of the second pressure control chamber 528 is adjusted, that is, a displacement stroke amount of the second control spring 532 is adjusted so that sedimentation created between the second pressure control chamber 528 and the first pressure control chamber 508 can be reliably eliminated by the ink flow from the second pressure control chamber 528. Further, in the second circulation, since ink flows into the first pressure control chamber 508 through the first bubble storage flow path 914, bubbles staying in the supply flow path 418 can be discharged. Incidentally, bubbles staying in the supply flow path 418 are generally removed by discharge of ink from the ejection opening 410. Therefore, the execution of the second circulation in the present embodiment can avoid the necessity of execution of an ink ejection operation to remove bubbles staying in the supply flow path 418 and save the consumed amount of ink.

### Effect and Advantage

In the first embodiment described above, the collection flow path 924 is connected to the flow path 544 between the circulation pump 322 and the second pressure control chamber 528. In contrast, in the second embodiment, the collection flow path 1224 is connected to the flow path 544 between the circulation pump 322 and the first pressure control chamber 508. Accordingly, in the second embodiment, the ink flow in the direction opposite to the first embodiment can be produced in the second circulation. Therefore, the same effect and advantage as the first embodiment can be achieved and bubbles staying in the supply flow path 418 can be removed without discharging ink.

### Other Embodiments

The above embodiments may be modified as shown in (1) to (7) below.

(1) In the first embodiment described above, the collection flow path 924 is connected to a predetermined position of the flow path 544 between the second pressure control chamber 528 and the circulation pump 322. However, the position is not limited to this. For example, the collection flow path 924 may be connected to any position between the pressure chamber 408 of the printing element substrate 302 and the circulation pump 322 including the collection flow path 420, the connection flow path 918, the second bubble storage flow path 920, and the second pressure control chamber 528. In other words, the collection flow path 924 may be connected to any position downstream of the pressure chamber 408 and upstream of the circulation pump 322.

In the second embodiment described above, the collection flow path 1224 is connected to a predetermined position of the flow path 544 between the circulation pump 322 and the first pressure control chamber 508. However, the position is not limited to this. For example, the collection flow path 924 may be connected to any position between the pressure chamber 408 of the printing element substrate 302 and the circulation pump 322 including the supply flow path 418, the connection flow path 916, the first bubble storage flow path 914, and the first pressure control chamber 508. In other words, the collection flow path 924 may be connected to any position upstream of the pressure chamber 408 and downstream of the circulation pump 322.

Incidentally, “upstream” and “downstream” described above indicate upstream and downstream in the direction of ink flow in a case where ink is circulated in the first circulation.

(2) In the embodiments described above, the collection path 908, into which ink flows through the collection tube 24, is connected to the supply path 902 connected to the ink tank 18. However, the configuration is not limited to this. For example, a sub tank capable of temporarily storing ink flowing out of the collection path 908 may be provided such that ink flows from the sub tank into the supply path 902. In this case, the collection valve 910 is provided between the sub tank and the supply path 902. Alternatively, the collection path 908 may be connected to the ink tank 18 such that ink flows from the collection path 908 into the ink tank 18. In this case, the collection valve 910 is provided between the collection path 908 and the ink tank 18 and the supply valve 906 is not provided. Accordingly, bubbles produced in the circulation path can be gathered into the sub tank or the ink tank 18 and the intrusion of bubbles into the circulating ink can be suppressed. Incidentally, in order to improve bubble collection efficiency, for example, the collection flow paths 924 and 1224 may be connected to the vicinity of the downstream sides of the first bubble storage flow path 914 and second bubble storage flow path 920.

(3) Although not particularly described in the first embodiment, in the second circulation, the circulation pump 322 may be driven at a greater pump frequency than the first circulation. This makes it possible to reliably increase the flow velocity of ink circulating through the first pressure control chamber 508, the flow path 542, the second pressure control chamber 528, and the flow path 544 and, for example, reliably eliminate sediment staying in the pressure control vales 502 and 522 and the orifices 546 and 548. In the first embodiment described above, one of the second circulation in which the circulation pump 322 is not driven and the second circulation in which the circulation pump 322 is driven at a greater pump frequency than the first circulation may be selectively executed or both of them may be executed.

(4) In the embodiments described above, the so-called serial scan type printing apparatus which performs printing by ejecting ink to a print medium M conveyed in the Y direction while moving the print head 16 in the X direction is described as an example. However, the present invention is also applicable to a so-called full line type printing apparatus with a print head in which ejection openings 410 are arrayed in a length corresponding to a width direction of a print medium M. In a case where the present invention is applied to the full line type printing apparatus, some of the features provided integrally with the print head 16b such as the first pressure control chamber 508, the second pressure control chamber 528, the printing element substrate 302, and the circulation pump 322 may be separately provided.

(5) In the embodiments described above, as a bubble storage section storing bubbles in ink, the first bubble storage flow path 914 is provided between the first pressure control chamber 508 and the printing element substrate 302. The second bubble storage flow path 920 is also provided between the second pressure control chamber 528 and the printing element substrate 302. However, either of the first bubble storage flow path 914 and the second bubble storage flow path 920 may be provided as the bubble storage section.

(6) In the embodiments described above, in the print head 16b, the circulation unit 306a which can collect ink to the ink supply unit 20 is used only for the white ink prone to cause sedimentation. However, the use is not limited to this. For example, the circulation unit 306a may be used also for the light cyan and light magenta inks which are less prone to cause sedimentation. In this case, under the control of the control section 1006 (CPU 1008), the first circulation is executed for the white, light cyan, and light magenta inks at the timing of execution of the first circulation. The second circulation is executed for the white ink and not executed for the light cyan and light magenta inks at the timing of execution of the second circulation.

(7) The embodiments described above and various modifications shown in (1) to (6) may be combined as appropriate.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-084328, filed May 23, 2023, which is hereby incorporated by reference wherein in its entirety.

What is claimed is:

1. A liquid ejection apparatus comprising:
a first pressure control chamber controlled to have a first negative pressure;
a second pressure control chamber connected to the first pressure control chamber through a flow path and controlled to have a second negative pressure less than the first negative pressure;
an ejection unit configured to eject, from an ejection opening, liquid supplied from the first pressure control chamber and collect, to the second pressure control chamber, liquid not ejected from the ejection opening;
a supply unit configured to supply stored liquid to the first pressure control chamber and collect liquid from the first pressure control chamber, the second pressure control chamber, and the ejection unit; and
a circulation control unit configured to control circulation of liquid among the first pressure control chamber, the second pressure control chamber, the ejection unit, and the supply unit,
wherein the circulation control unit is configured to execute:
first circulation in which liquid flows from the first pressure control chamber, passes through the ejection unit and the second pressure control chamber, and then returns to the first pressure control chamber by using a pressure difference between the first pressure control chamber and the second pressure control chamber; and
second circulation in which liquid is collected from the first pressure control chamber, the second pressure control chamber, and the ejection unit to the supply unit without being controlled by negative pressures corresponding to the first pressure control chamber and the second pressure control chamber, respectively, while liquid is supplied to the first pressure control chamber.

2. The liquid ejection apparatus according to claim 1, wherein
the flow path connecting the first pressure control chamber to the second pressure control chamber includes a flow path capable of transferring liquid from the first pressure control chamber to the second pressure control chamber by a first pump, and
in the second circulation, liquid in the first pressure control chamber, the second pressure control chamber, and the ejection unit is collected from a predetermined position upstream of the first pump and downstream of a pressure chamber in which liquid is provided with energy to eject liquid from the ejection opening in the ejection unit in a direction of liquid flow in the first circulation.

3. The liquid ejection apparatus according to claim 2, wherein
the predetermined position is positioned between the first pump and the second pressure control chamber.

4. The liquid ejection apparatus according to claim 2, wherein
in the second circulation, the supply unit produces a negative pressure to collect liquid, and
a negative pressure value applied to the second pressure control chamber by the supply unit in the second circulation is greater than a negative pressure value applied to the second pressure control chamber by the first pump in the first circulation.

5. The liquid ejection apparatus according to claim 1, wherein
the flow path connecting the first pressure control chamber to the second pressure control chamber includes a flow path capable of transferring liquid from the first pressure control chamber to the second pressure control chamber by a first pump, and
in the second circulation, liquid in the first pressure control chamber, the second pressure control chamber, and the ejection unit is collected from a predetermined position downstream of the first pump and upstream of a pressure chamber in which liquid is provided with energy to eject liquid from the ejection opening in the ejection unit in a direction of liquid flow in the first circulation.

6. The liquid ejection apparatus according to claim 5, wherein
the predetermined position is positioned between the first pump and the first pressure control chamber.

7. The liquid ejection apparatus according to claim 1, wherein
the supply unit comprises:
a storage unit configured to store liquid; and
a second pump configured to transfer, to the first pressure control chamber, liquid stored in the storage unit and collected liquid.

8. The liquid ejection apparatus according to claim 7, wherein
in execution of the first circulation, the supply unit permits transfer of liquid stored in the storage unit to the first pressure control chamber and prohibits inflow of collected liquid, and
in execution of the second circulation, the supply unit prohibits transfer of liquid stored in the storage unit to the first pressure control chamber and permits inflow of collected liquid.

9. The liquid ejection apparatus according to claim 7, wherein
the supply unit further comprises a storage section configured to store collected liquid, and
in the second circulation, liquid collected and flowing into the supply unit flows into the storage section and is then transferred from the storage section to the first pressure control chamber by the second pump.

10. The liquid ejection apparatus according to claim 7, wherein
in the second circulation, liquid collected and flowing into the supply unit flows into the storage unit and liquid is transferred from the storage unit to the first pressure control chamber by the second pump.

11. The liquid ejection apparatus according to claim 1, wherein
each of the first pressure control chamber and the second pressure control chamber comprises:
a pressure control mechanism configured to control a pressure inside the chamber controlled to a negative pressure; and
a change film configured to change a volume of the chamber according to the pressure inside the chamber.

12. The liquid ejection apparatus according to claim 11, wherein
the pressure control mechanism comprises:
an orifice to allow liquid to flow into the chamber;
a valve which opens the orifice to allow liquid to flow into the chamber in a case where the pressure inside the chamber becomes equal to or less than a predetermined pressure by outflow of liquid from the chamber, and closes the orifice to prevent liquid from flowing into the chamber in a case where the pressure inside the chamber exceeds the predetermined pressure by inflow of liquid into the chamber; and
a spring which biases the change film in a direction in which the volume of the chamber increases.

13. The liquid ejection apparatus according to claim 12, wherein
the volume of the second pressure control chamber in a case where the spring expands corresponds to an amount of liquid capable of eliminating sedimentation of contained material of liquid created between the second pressure control chamber and the first pressure control chamber by liquid flow in the second circulation.

14. The liquid ejection apparatus according to claim 1, wherein
a bubble storage unit configured to store a bubble produced in liquid is provided in at least one of a position between the first pressure control chamber and the ejection unit and a position between the second pressure control chamber and the ejection unit.

15. The liquid ejection apparatus according to claim 1, wherein
the first circulation is executed during an operation of ejecting liquid from the ejection opening.

16. The liquid ejection apparatus according to claim 1, wherein
the second circulation is executed at a timing at which a period during which an operation of ejecting liquid from the ejection opening is not executed exceeds a predetermined period.

17. The liquid ejection apparatus according to claim 1, wherein
the first pressure control chamber, the second pressure control chamber, and the ejection unit are integrally provided in a liquid ejection head together with a flow path for liquid circulation.

18. The liquid ejection apparatus according to claim 17, wherein
the liquid ejection head ejects liquid from the ejection opening in the ejection unit while moving in a predetermined direction.

19. The liquid ejection apparatus according to claim 1, wherein
the liquid ejection apparatus is capable of ejecting a plurality of liquids,
the first pressure control chamber, the second pressure control chamber, the ejection unit, and the supply unit are provided for each of the liquids, and
the circulation control unit executes the first circulation for all the liquids and executes the second circulation for a predetermined liquid.

20. A liquid ejection head comprising:
a first pressure control chamber controlled to have a first negative pressure;
a second pressure control chamber connected to the first pressure control chamber through a flow path and controlled to have a second negative pressure lower than the first negative pressure; and
an ejection unit configured to eject, from an ejection opening, liquid supplied from the first pressure control chamber and collect, to the second pressure control chamber, liquid not ejected from the ejection opening,
wherein first circulation and second circulation can be executed,
in the first circulation, liquid flows from the first pressure control chamber, passes through the ejection unit and the second pressure control chamber, and then returns to the first pressure control chamber by using a pressure difference between the first pressure control chamber and the second pressure control chamber; and
in the second circulation, liquid is collected from the first pressure control chamber, the second pressure control chamber, and the ejection unit without being controlled by negative pressures corresponding to the first pressure control chamber and the second pressure control chamber, respectively, while liquid is supplied to the first pressure control chamber.
